(19) United States
(12) Patent Application Publication
(10) Pub. No.: US 2018/0103227 A1
(43) Pub. Date: Apr. 12, 2018

(54) MATURING CHARGED COUPLED DEVICE (CCD) PHOTON COUNTING FOR SPACEFLIGHT

(71) Applicant: U.S.A. as represented by the Administrator of the National Aeronautics Space Administration, Washington, DC (US)

(72) Inventor: UDAYAN MALLIK, SILVER SPRING, MD (US)

(21) Appl. No.: 15/291,497

(22) Filed: Oct. 12, 2016

(51) Int. Cl. H04N 5/3745; H04N 5/376

(52) U.S. Cl. CPC H04N 5/37455; H04N 5/37452; H04N 5/3765; H04N 5/37457

(57) ABSTRACT

A FPGA and DAC based shaped clock controller for EMCCD devices is provided. The controller may allow clocking of an EMCCD in low noise mode to enable imaging single photon events at each pixel in the image. An algorithm for spatially selective gain clocking may enable an EMCCD camera to image very dim objects near very bright objects in a high contrast instrument. Spatially selective gain clocking is one of the first steps that is required to begin to unravel objects near a bright source.

### STATEMENT OF FEDERAL RIGHTS

The invention described herein was made by employees of the United States Government and may be manufactured and used by or for the Government for Government purposes without the payment of any royalties thereon or therefore.

### FIELD

The present invention generally relates to a photon counting camera for space flight.

### BACKGROUND

An electron multiplying charged coupled device (EMCCD) is a quantitative digital camera that detects single photon events while maintaining high quantum efficiency. The EMCCD contains a charge multiplication architecture to amplify low lights signals before readout.

The primary challenge when implementing EMCCD photon counting is a clock induced charge (CIC). With CIC, energy from a clock signal detaches valence electrons and generates an image signal. This image signal is not the result of integration of light. Instead, this image signal occurs in the transfer registers or in the readout and multiplication registers. CIC is the dominant source of read noise in photon counting EMCCD cameras. Furthermore, CIC effects low light cameras more than regular cameras because CIC makes it impossible to distinguish between small, low luminosity objects in space and noise.

Thus, an alternative approach may be beneficial.

### SUMMARY

Certain embodiments of the present invention may provide solutions to the problems and needs in the art that have not yet been fully identified, appreciated, or solved by photon counting cameras.

In an embodiment, an apparatus may include a controller card configured to receive a digital clock pattern from a computing device and store the digital pattern in an input logic of the controller for each queue in the controller. The apparatus may also include a plurality of digital-to-analog converters (DACs) configured to convert the digital clock pattern to an analog clock signal. The apparatus may further include a set of amplifiers for each of the plurality of DACs configured to amplify the analog clock signal from each of the plurality of DACs to a voltage signal that is equivalent to a level of a charged coupled device (CCD).

In another embodiment, an apparatus may include a DACs configured to convert a sequence of digital mode numbers to an analog mode wave. The apparatus may also include a field programmable gate array (FPGA) configured to clock each of the plurality of DACs with the sequence of digital mode numbers. The sequence of digital mode numbers may represent an EMCCD.

In yet another embodiment, an apparatus may include a The apparatus may also include a FPGA configured to clock each of the plurality of DACs with the sequence of digital mode numbers. The sequence of digital mode numbers may represent an EMCCD. The FGPA may be based on a shaped clock controller for a photon counting EMCCD camera and may include a spatially selective gain clocking scheme to enable an EMCCD in high gain mode to image very dim objects near very bright stars.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a shaped clock controller, according to an embodiment of the present invention.

FIG. 2 is a block diagram illustrating a full planned camera architecture, according to an embodiment of the present invention.

FIG. 3 is a block diagram illustrating a EMCCD clock generator, according to an embodiment of the present invention.

FIG. 4 is a graph illustrating a square wave, according to an embodiment of the present invention.

FIG. 5 is a graph illustrating a clock signal, according to an embodiment of the present invention.

FIGS. 6 and 7 illustrate high contrast imaging, according to an embodiment of the present invention.

### DETAILED DESCRIPTION OF THE EMBODIMENTS

Embodiments of the present invention pertain to a maturing CCD photon counting camera. In some embodiments, the CCD photon counting camera includes a DAC circuit based clock generator architecture to create shaped clock signals for an EMCCD. For example, the architecture may include DACs to convert a sequence of digital mode numbers to an analog mode wave. Each of the DACs may be clocked by a FPGA with a digital stream representing an EMCCD clock waveform. For each DAC, a corresponding analog amplifier may convert the output of the DAC to a voltage signal. An additional set of amplifiers may amplify the voltage signal to a level of EMCCD clock signals.

This architecture may enable a controller to generate very smooth clock signals, each having a very smooth waveform at the amplified levels. In some embodiments, the shape of the analog signal may be controlled at a very fine level by controlling the digital pattern. This feature has a major, additional benefit as the EMCCD's performance changes in space because of radiation effects. The DAC circuit based clock generator architecture enables a mission to re-optimize the shape of the detector's clocks from the ground to maintain a signal-to-noise ratio (SNR) of the images being captured.

This architecture may have additional benefits. For example, the same architecture can be used to clock different CCDs or EMCCDs. Therefore, if a mission or instrument decides to change its sensor due to unforeseen circumstances, the same controller can be reconfigured in software/FPGA firmware to clock the new sensor. This flexibility is currently not available in other architectures.

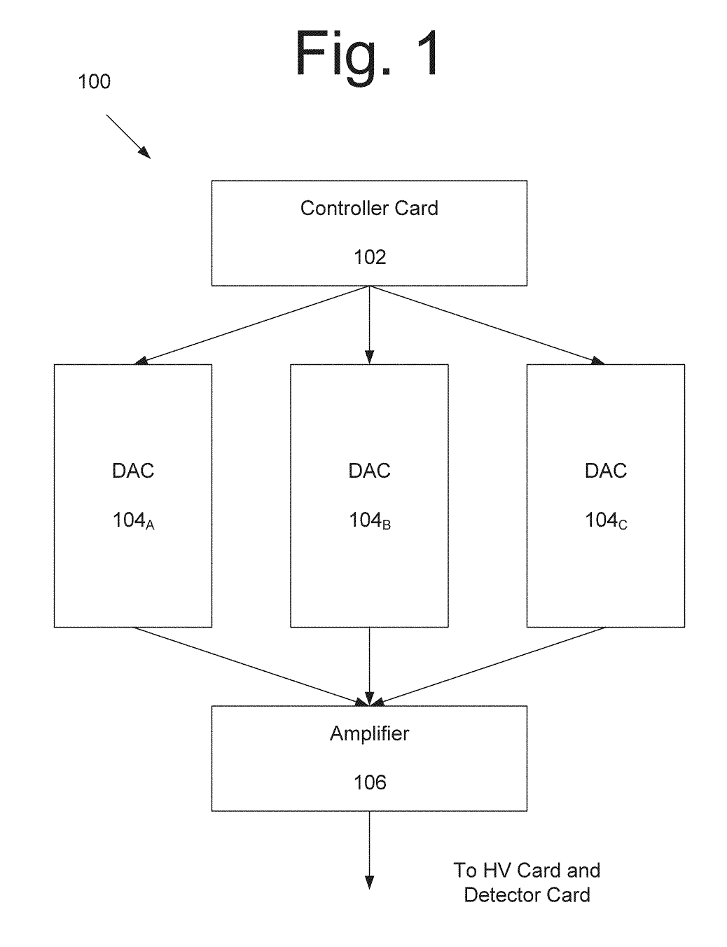

FIG. 1 is a block diagram 100 illustrating a shaped clock controller architecture, according to an embodiment of the present invention. In some embodiments, the shaped clock controller architecture may include a controller card 102 that receives digital clock waveforms via a universal serial bus (USB) link or connection. In certain embodiments, the digital clock waveforms (or patterns) are received from a personal computer. These waveforms are then transmitted to each DAC card 104_{A-C}. In some embodiments, each DAC card 104_{A-C} may include a FPGA and multiple DACs.

Each DAC card 104_{A-C} may convert the waveform to an analog signal, and transmit the analog signal to amplifiers 106. In some embodiments, amplifier 106 may include two successive sets of amplifiers for each DAC card 104_{A-C}. Amplifier 106 may convert the analog signal to a voltage signal equivalent to CCD levels, and transmit the voltage signal to a high voltage card and detector card.

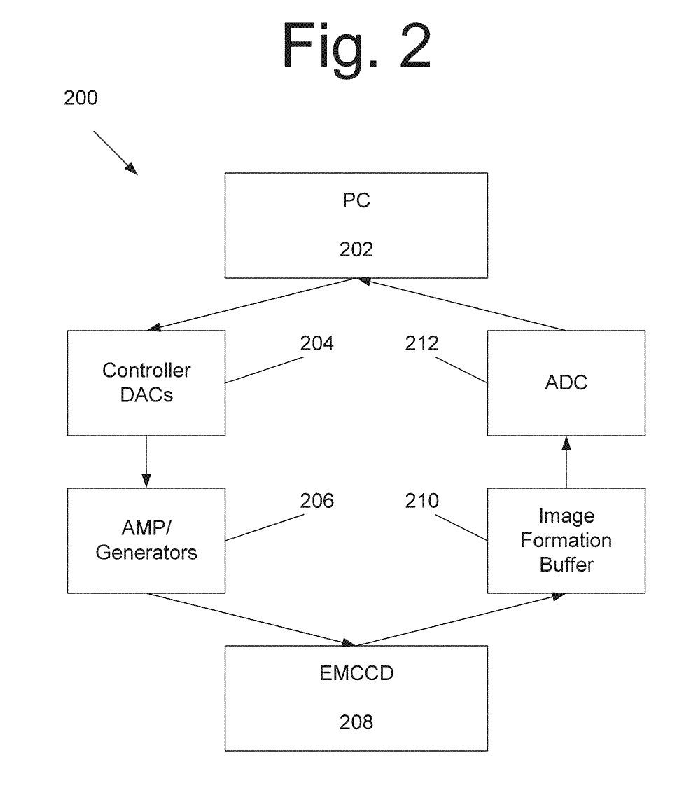

FIG. 2 is a block diagram 200 illustrating a full planned camera architecture, according to an embodiment of the present invention. In some embodiments, personal computer (PC) may download clocking patterns to a controller 204. Once all of the clocking patterns have been downloaded to controller 204, controller 204 may begin to generate clock signals for the EMCCD 208. As mentioned above, the clocking patterns, which are in waveform, may be converted to analog clocking signals by DACs. These signals may then be amplified by amplifier (or generator) 206 to a level that is equivalent to CCD levels. EMCCD 208 may generate image signals. Once the image signal is generated, image formation buffer 210 may convert the output signal from each pixel to a form that can be digitized by an analog-to-digital converter (ADC). The digitized image signal may then be sent to PC 202 for display.

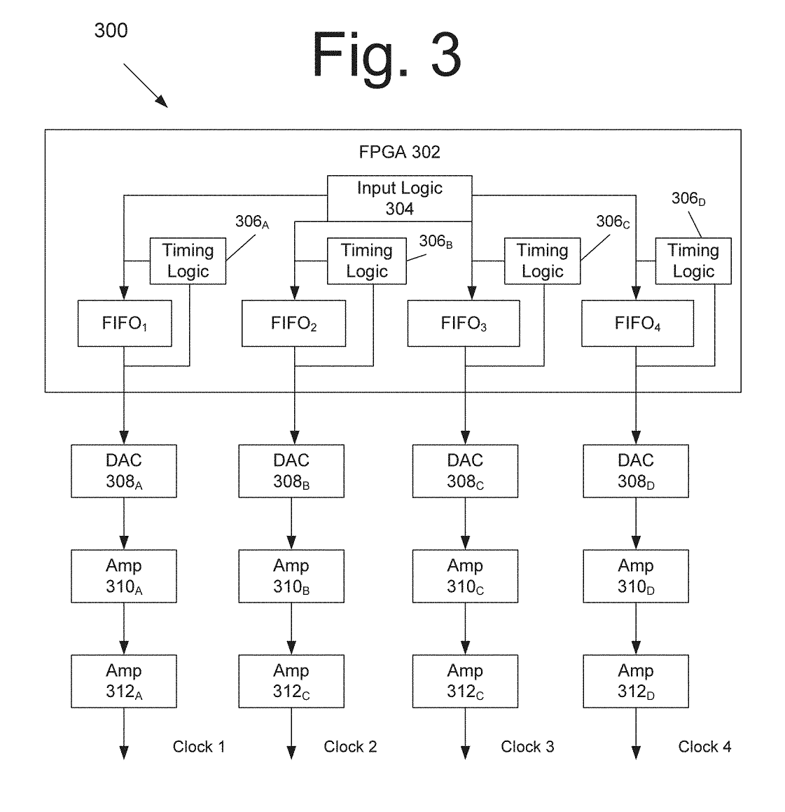

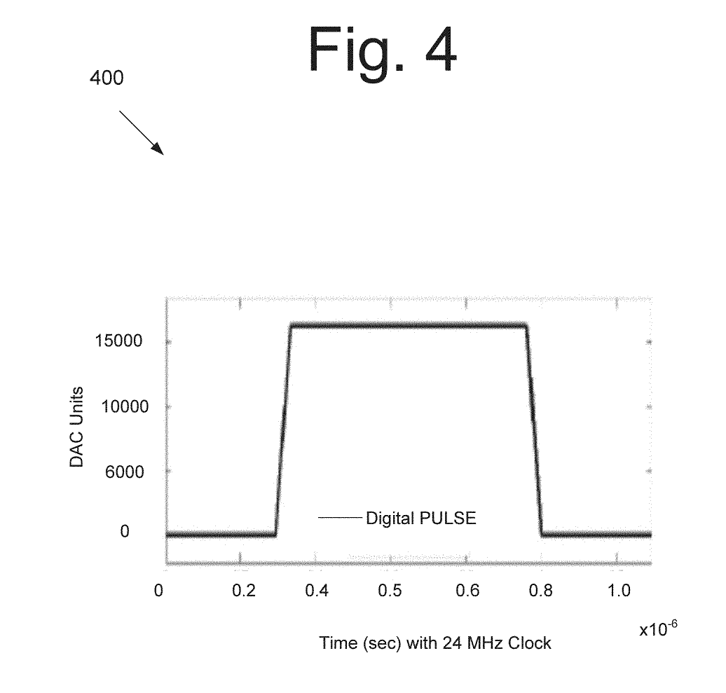

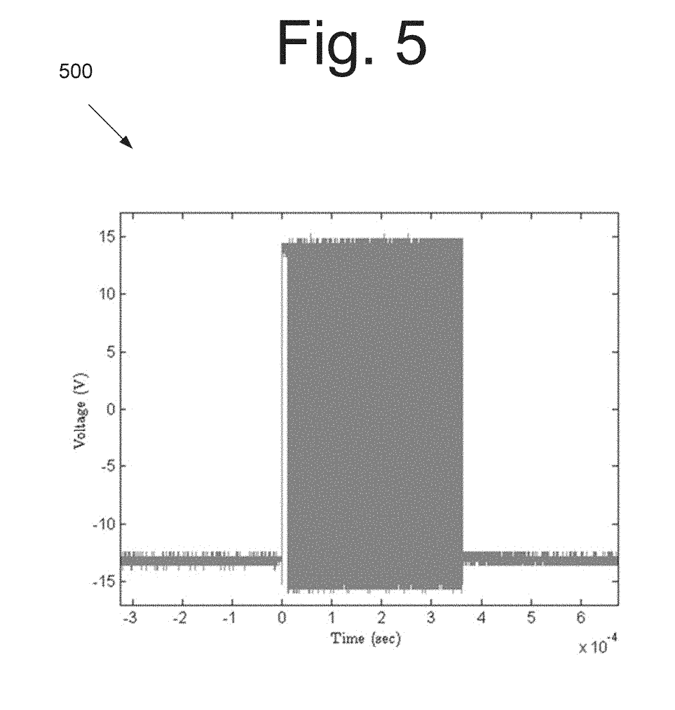

FIG. 3 is a block diagram 300 illustrating a EMCCD clock generator, according to an embodiment of the present invention. In some embodiments, EMCCD clock generator (OR DAC card) may include a FPGA 302, DACs 308_{A-D}, a first set and second set of amplifiers 310_{A-D} and 312_{A-D}. In other words, each DAC 308_{A-D} has a set of amplifiers—a first amplifier and a second amplifier—associated with it.

In some embodiments, digital patterns may be downloaded onto FPGA 302 from a personal computer (PC) for each EMCCD clock, and stored as input logic 304. FPGA 302 may also include timing logic 306_{A-D} that may be used to convert a digital pattern to a valid EMCCD clocking sequence. The timing logic may control the time duration during which the first in first out (FIFO) is active during clocking to control the clocking pattern being sent to the EMCCD.

In some embodiments, controller card receives digital pattern(s) from a PC through a USB link, and store the digital clock patterns in input logic 304. This process may be repeated for each FIFO₁ . . . FIFO₄ in a controller. Once each FIFO₁ . . . FIFO₄ has received a digital clock pattern from the controller card, the controller card may generate a signal instructing DAC cards 308_{A} . . . 308_{D} to start clocking the EMCCD. Once this process begins, internal timing logic 306_{A} . . . 306_{D} in each clock card begins clocking FIFO₁ . . . FIFO₄ to generate an input for each DAC 308_{A} . . . 308_{D}. DACs 308_{A} . . . 308_{D} and amplifiers 310_{A} . . . 310_{D} and 312_{A} . . . 312_{D} may convert the digital pattern to an analog mode clock signal for the EMCCD.

It should be appreciated that each clock card may communicate with other clock cards and the controller card using handshaking signals. This allows different clock cards to start and stop their clock patterns so that different functions in the EMCCD can be completed at the required times. This also allows the controller to track the phase of each clock during the clocking process. This helps the controller card to generate signals for various components in the controller that form the image signal—digitize the image signal and send the image signal to a PC.

In certain embodiments, DACs 308_{A-D} may receive the digital clock pattern from FPGA 302, and may convert the digital pattern into an analog mode current to represent a clock. See, for example, graph 400 showing a digital waveform (or pattern) and graph 500 showing an analog mode (or clock signal), according to an embodiment of the present invention. It should be appreciated that in some embodiments that there are four DACs in each card, because the FGPA used may contain only enough PINS to support 4 DACs in each card. In other words, the architecture can be modified by using a more sophisticated FPGA that contains a larger numbers of input/output (IO) pins to clock all the DACs necessary for the instrument.

The analog mode current may be amplified by a first set of amplifiers 310_{A-D} and a second set of amplifiers 312_{A-D}. In some embodiments, first set of amplifiers 310_{A-D} may be a +/−5 V amplifier, and second set of amplifiers 312_{A-D} may be a +/−15 V amplifier. Amplifiers 310_{A-D} and 312_{A-D} may convert the analog mode current to voltage mode CCD clock levels. In some embodiments, the EMCCD may require less amplification.

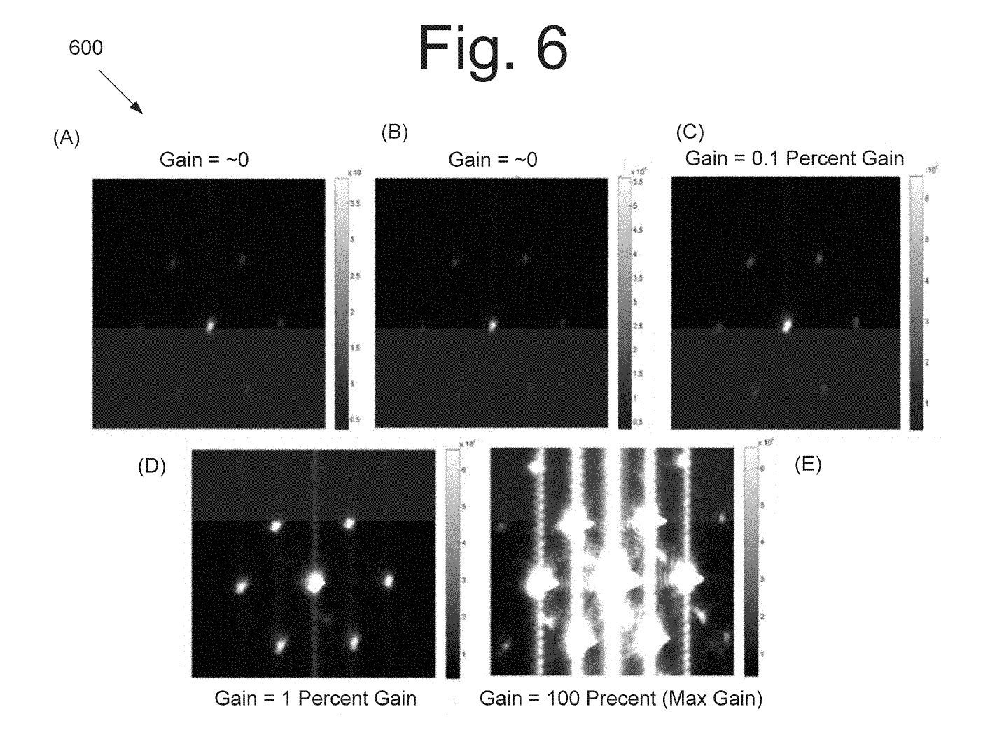

FIG. 6 illustrates starlight saturation during high contrast imaging 500 with an EMCCD, according to an embodiment of the present invention. In this example, images A, B, C, D, and E are taken with a 40 nm band pass filter a neutral density filter at the source to reduce flux. In Image C, for example, the starlight is already saturated at 0.1 percent gin, and in Image E, the speckle pattern is highly visible at Max Gain. It should be appreciated that the gain shown in FIG. 6 reinforces the argument that the star becomes larger than its actual size when the EMCCD is being operated with some amount of gain. It should further be appreciated that the star begins to expand at negligible gain. This has consequences for high contrast imaging instruments, which are trying to look for a dim object very near the star.

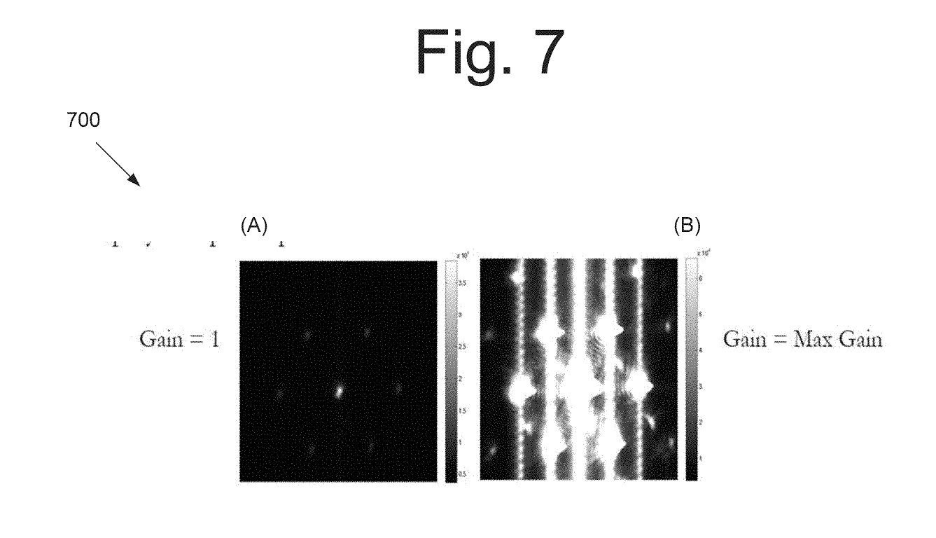

FIG. 7 illustrating high contrast imaging 700 with an EMCCD, according to an embodiment of the present invention. In some embodiments, the photon counting controller may implement arbitrary clocking waveforms. It should be appreciated that spatially selective gain clocking is a potential solution for starlight saturation. For example, the rows of the image containing the star and the six side-lobes (see Image A) can be clocked at a lower gain level than the rows which do not. This may keep the star within 80 percent of full well and still amplify the speckle pattern (see Image B).

A FPGA and DAC based shaped clock controller for EMCCD devices is provided. The controller may allow clocking of an EMCCD in low noise mode to enable imaging single photon events at each pixel in the image. The benefit of FPGA based designs is that FPGAs are regularly flown on flight missions and are easier to space qualify. An algorithm for spatially selective gain clocking enables an EMCCD camera to image very dim objects near very bright objects in a high contrast instrument. Starlight in a high-contrast instrument, imaged with a high gain EMCCD, tends to begin to enlarge itself because of optical effects. This means that very dim objects, such as planets, very near the star become invisible to a camera because the star on the camera looks bigger than it really is. This is caused by optical effects in the high-contrast imaging instrument. Spatially selective clocking is one of the first steps that is required to begin to unravel objects near a bright source.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a controller card configured to receive a digital clock pattern from a computing device and store the digital pattern in an input logic of a controller for each queue in the controller; and
a plurality of digital-to-analog converters (DACs) configured to convert the digital clock pattern to an analog clock signal; and
a set of amplifiers for each of the plurality of DACs configured to amplify the analog clock signal from each of the plurality of DACs to a voltage signal that is equivalent to a level of a charged coupled device (CCD).

2. The apparatus of claim 1, wherein each queue is a first-in-first-out (FIFO) queue.

3. The apparatus of claim 2, wherein a timing logic is stored in the controller for each FIFO queue and controls a time duration for when each FIFO queue is active.

4. The apparatus of claim 1, wherein the controller card is configured to generate a signal instructing each of the plurality of DACs to begin converting the digital clock pattern to the analog clock signal.

5. The apparatus of claim 4, wherein a timing logic is configured to clock each queue to generate an input for each of the plurality of DACs.

6. The apparatus of claim 1, wherein the set of amplifiers comprises a first amplifier and a second amplifier, the first amplifier comprising a lower voltage than the second amplifier.

7. The apparatus of claim 1, wherein each of the plurality of DACs are clocked by a field programmable gate array with a digital stream representing an electron multiplying charged couple device (EMCCD).

8. An apparatus, comprising:
a plurality of digital-to-analog converts (DACs) configured to convert a sequence of digital mode numbers to an analog mode wave; and
a field programmable gate array (FPGA) configured to clock each of the plurality of DACs with the sequence of digital mode numbers, wherein the sequence of digital mode numbers represents an electron multiplying charged coupled device (EMCCD).

9. The apparatus of claim 8, further comprising:
a set of amplifiers for each of the plurality of DACs, wherein the set of amplifiers comprises a first amplifier and a second amplifier.

10. The apparatus of claim 9, wherein the first amplifier is configured to convert the analog mode wave to a voltage signal.

11. The apparatus of claim 10, wherein the second amplifier is configured to amplify the voltage signal to a level of EMCCD clock signals.

12. The apparatus of claim 8, wherein the sequence of digital mode numbers for each EMCCD clock signal is stored as an input logic.

13. The apparatus of claim 8, wherein the FPGA is configured to store timing logic for each of the plurality of DACs, the timing logic is used to convert the sequence of digital model numbers to a valid EMCCD clocking sequence.

14. The apparatus of claim 13, wherein the timing logic is configured to control a time duration during which an associated first in first out (FIFO) queue is active.

15. An apparatus, comprising:
a field programmable gate array (FPGA) configured to clock each of the plurality of DACs with the sequence of digital mode numbers, wherein
the sequence of digital mode numbers represents an electron multiplying charged coupled device (EMCCD), and
the FGPA is based on a shaped clock controller for a photon counting EMCCD camera and comprises a spatially selective gain clocking scheme to enable the EMCCD in high gain mode to image very dim objects near very bright stars.

16. The apparatus of claim 15, further comprising:
a plurality of digital-to-analog converts (DACs) configured to convert a sequence of digital mode numbers to an analog mode wave.

17. The apparatus of claim 15, further comprising:
a set of amplifiers for each of the plurality of DACs, wherein the set of amplifiers comprises a first amplifier and a second amplifier.

18. The apparatus of claim 17, wherein the first amplifier is configured to convert the analog mode wave to a voltage signal.

19. The apparatus of claim 18, wherein the second amplifier is configured to amplify the voltage signal to a level of EMCCD clock signals.

20. The apparatus of claim 15, wherein the FPGA is configured to store timing logic for each of the plurality of DACs, the timing logic is used to convert the sequence of digital model numbers to a valid EMCCD clocking sequence, and
the timing logic is configured to control a time duration during which an associated first in first out (FIFO) queue is active.
